(19) United States
(12) Patent Application Publication
(10) Pub. No.: US 2026/0050154 A1
(43) Pub. Date: Feb. 19, 2026

(54) ILLUMINATION OPTICAL SYSTEM AND ENDOSCOPE

(71) Applicant: FUJIFILM Corporation, Tokyo (JP)

(72) Inventor: Keisuke HARADA, Saitama (JP)

(73) Assignee: FUJIFILM Corporation, Tokyo (JP)

(21) Appl. No.: 19/283,203

(22) Filed: Jul. 28, 2025

(30) Foreign Application Priority Data
Aug. 13, 2024 (JP) 2024-135047

(51) Int. Cl. G02B 23/24; F21V 8/00

(52) U.S. Cl. CPC G02B 23/2469; G02B 6/0051

(57) ABSTRACT

An illumination optical system includes a light guide of an endoscope and a diffuser that is disposed on an emission side of the light guide and diffuses light emitted from the light guide. The diffuser includes a substrate and a diffusion surface. A light diffusion angle distribution on the diffusion surface varies depending on an incidence angle of light incident on the diffusion surface. In a case where a half width at half maximum of the light diffusion angle distribution in a case where the incidence angle is equal to or greater than a predetermined threshold value is denoted by φa and a half width at half maximum of the light diffusion angle distribution in a case where the incidence angle is less than the threshold value is denoted by φb, the diffusion surface satisfies Conditional Expression represented by “0.1<φa/φb<0.7”.

### CROSS-REFERENCE TO RELATED APPLICATIONS

This application claims priority from Japanese Patent Application No. 2024-135047, filed on Aug. 13, 2024, the entire disclosure of which is incorporated herein by reference.

### BACKGROUND OF THE INVENTION

### Technical Field

A technology of the present disclosure relates to an illumination optical system and an endoscope.

### Related Art

JP7141540B discloses an illumination optical system for an endoscope that is provided in contact with an end surface of a light guide at a distal end part of an insertion unit of an endoscope and includes a diffuser provided on the end surface of the light guide and diffusing light emitted from the light guide.

JP2000-338312A discloses a holographic diffuser that is used as a screen in a display device, an application for shaping a beam, or an application requiring light diffusion, is recorded using a holographic method, and has the same diffusion characteristics over all surfaces of a diffuser body where a unique or main optical axis is not present.

JP2003-294952A discloses a hologram screen that diffracts and scatters video light projected by a video projection device to display a video.

### SUMMARY

In recent years, there has been a demand for an illumination optical system that is configured to be small and has a wide light distribution and good transmission efficiency.

The present disclosure provides an illumination optical system that is configured to be small and has a wide light distribution and good transmission efficiency, and an endoscope including the illumination optical system.

According to an aspect of the technology of the present disclosure, there is provided an illumination optical system comprising a light guide of an endoscope and a diffuser that is disposed on an emission side of the light guide and diffuses light emitted from the light guide. The diffuser includes a substrate and a diffusion surface that is provided on a light guide-side surface of the substrate, a light diffusion angle distribution on the diffusion surface varies depending on an incidence angle of light incident on the diffusion surface, and Conditional Expression (1), which is represented by 0.1<φa/φb<0.7 (1), is satisfied. Symbols used in the conditional expression are defined as follows. A half width at half maximum of the light diffusion angle distribution in a case where the incidence angle is equal to or greater than a predetermined threshold value is denoted by φa. A half width at half maximum of the light diffusion angle distribution in a case where the incidence angle is less than the threshold value is denoted by φb. Units of φa and φb are degrees.

It is preferable that the illumination optical system according to the aspect satisfies at least one of Conditional Expression (2), (3), (4), (5), (6), or (7). Symbols used in the conditional expression are defined as follows. A thickness of the diffuser is denoted by t. A radius of an outermost portion of the diffuser is denoted by H. A radius of the light guide is denoted by G. The threshold value is denoted by θh. A unit of θh is degrees. A refractive index of the substrate with respect to a d line is denoted by N. A half width at a value of ¼ of a maximum amount of light in the light diffusion angle distribution in a case where the incidence angle is equal to or greater than the threshold value is denoted by φaq. A half width at a value of ¼ of a maximum amount of light in the light diffusion angle distribution in a case where the incidence angle is less than the threshold value is denoted by φbq.

$$0.4 < ( t / ( H - G ) ) \times tan ( θ h / N + φ a ) < 2 \qquad ( 2 )$$

$$0.1 < ( t / H ) \times tan ( θ h / N + φ b ) < 1 \qquad ( 3 )$$

$$0.3 < ( θ h / N + φ a ) / ( θ h / N + φ b ) < 1 \qquad ( 4 )$$

$$3 < φ a - θ h / N < 10 \qquad ( 5 )$$

$$0.5 < φ a / φ aq < 0.95 \qquad ( 6 )$$

$$0.5 < φ b / φ bq < 0.95 \qquad ( 7 )$$

In the illumination optical system according to the above-described aspect, the light guide may be configured to include a light shielding member on a central axis thereof.

According to another aspect of the technology of the present disclosure, there is provided an endoscope comprising the illumination optical system according to the above-described aspect.

According to the present disclosure, it is possible to provide an illumination optical system that is configured to be small and has a wide light distribution and good transmission efficiency, and an endoscope including the illumination optical system.

### BRIEF DESCRIPTION OF THE DRAWINGS

FIG. 1 is a cross-sectional view showing a configuration of an illumination optical system according to an embodiment corresponding to an illumination optical system of Example 1.

FIG. 2 is a diagram illustrating an action of a diffuser with respect to incident light having an incidence angle equal to or greater than a threshold value.

FIG. 3 is a diagram illustrating an action of the diffuser with respect to incident light having an incidence angle less than the threshold value.

FIG. 4 is a diagram showing a light diffusion angle distribution on a diffusion surface of the illumination optical system shown in FIG. 1.

FIG. 5 is a diagram showing a configuration and optical paths of the illumination optical system shown in FIG. 1 in a case where an incidence angle is equal to or greater than the threshold value.

FIG. 6 is a diagram showing a configuration and optical paths of the illumination optical system shown in FIG. 1 in a case where an incidence angle is less than the threshold value.

FIG. 7 is a diagram showing light distribution characteristics of the illumination optical system of Example 1.

FIG. 8 is a diagram showing a configuration and optical paths of an illumination optical system of Example 2 in a case where an incidence angle is equal to or greater than a threshold value.

FIG. 9 is a diagram showing a configuration and optical paths of the illumination optical system of Example 2 in a case where an incidence angle is less than the threshold value.

FIG. 10 is a diagram showing light distribution characteristics of the illumination optical system of Example 2.

FIG. 11 is a diagram showing a configuration and optical paths of an illumination optical system of Example 3 in a case where an incidence angle is equal to or greater than a threshold value.

FIG. 12 is a diagram showing a configuration and optical paths of the illumination optical system of Example 3 in a case where an incidence angle is less than the threshold value.

FIG. 13 is a perspective view showing a schematic configuration of a light guide of the illumination optical system of Example 3.

FIG. 14 is a diagram showing light distribution characteristics of the illumination optical system of Example 3.

FIG. 15 is a diagram showing a configuration and optical paths of an illumination optical system of Example 4 in a case where an incidence angle is equal to or greater than a threshold value.

FIG. 16 is a diagram showing a configuration and optical paths of the illumination optical system of Example 4 in a case where an incidence angle is less than the threshold value.

FIG. 17 is a diagram showing light distribution characteristics of the illumination optical system of Example 4.

FIG. 18 is a diagram showing a configuration and optical paths of an illumination optical system of Example 5 in a case where an incidence angle is equal to or greater than a threshold value.

FIG. 19 is a diagram showing a configuration and optical paths of the illumination optical system of Example 5 in a case where an incidence angle is less than the threshold value.

FIG. 20 is a diagram showing a light diffusion angle distribution on a diffusion surface of the illumination optical system of Example 5.

FIG. 21 is a diagram showing light distribution characteristics of the illumination optical system of Example 5.

FIG. 22 is a diagram showing a configuration and optical paths of an illumination optical system of Example 6 in a case where an incidence angle is equal to or greater than a threshold value.

FIG. 23 is a diagram showing a configuration and optical paths of the illumination optical system of Example 6 in a case where an incidence angle is less than the threshold value.

FIG. 24 is a diagram showing light distribution characteristics of the illumination optical system of Example 6.

FIG. 25 is a diagram showing a schematic configuration of an endoscope according to an embodiment.

### DETAILED DESCRIPTION

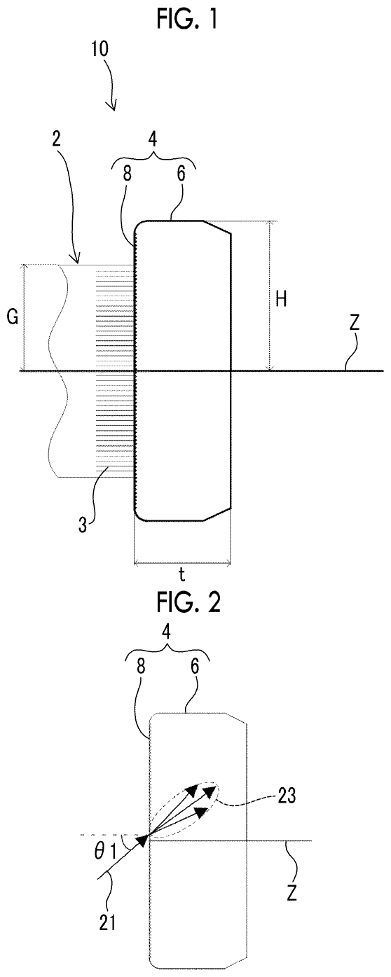

Embodiments of the present disclosure will be described in detail below with reference to the drawings. FIG. 1 shows a configuration of an illumination optical system 10 according to an embodiment of the present disclosure in a cross section including an optical axis Z. The illumination optical system 10 shown in FIG. 1 corresponds to Example 1 to be described later.

The illumination optical system 10 includes a light guide 2 of an endoscope and a diffuser 4 that is disposed on an emission side of the light guide 2 and diffuses light emitted from the light guide 2. The light guide 2 is composed of a bundle fiber in which a plurality of optical fibers 3 are bundled. The diffuser 4 includes a substrate 6 and a diffusion surface 8 that is provided on a light guide-side surface of the substrate 6. The diffusion surface 8 is a surface of the diffuser 4 closest to the light guide. The diffuser 4 is disposed such that the diffusion surface 8 is in close contact with or close to a distal end of the light guide 2.

Light emitted from a light source (not shown) is incident on the diffusion surface 8 of the diffuser 4 via the light guide 2, is diffused by the diffusion surface 8, passes through the substrate 6, and is then emitted from the diffuser 4 to be illumination light. In a case where the diffuser 4 is disposed at a distal end of an insertion unit of the endoscope, an irradiation target (not shown), which is an object to be observed, is illuminated with the illumination light. In FIG. 1, a left side is a light source side, and a right side is an irradiation target side.

The diffuser 4 is configured such that a light diffusion angle distribution on the diffusion surface 8 varies depending on an incidence angle of light incident on the diffusion surface 8. The “incidence angle of light incident on the diffusion surface 8” is an angle between a line perpendicular to the diffusion surface 8 and incident light. Further, the “light diffusion angle distribution” is an angle distribution of diffused light. The light diffusion angle distribution will be described later with reference to examples.

The diffuser 4 is configured such that a light diffusion angle distribution on the diffusion surface 8 varies depending on a predetermined threshold value for an incidence angle. In outline, the diffuser 4 is configured such that an angle width of a light diffusion angle distribution on the diffusion surface 8 is small in a case of incident light of which the incidence angle of light incident on the diffusion surface 8 is equal to or greater than a threshold value and an angle width of a light diffusion angle distribution on the diffusion surface 8 is large in a case of incident light of which the incidence angle of light incident on the diffusion surface 8 is less than the threshold value.

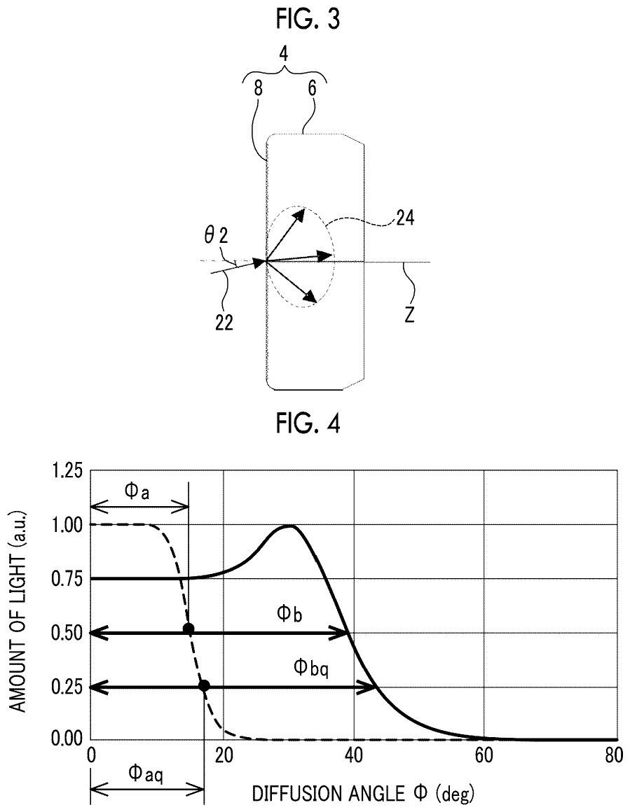

The above-described configuration of the diffusion surface 8 will be described with reference to FIGS. 2 and 3. FIGS. 2 and 3 are conceptual diagrams for description. FIG. 2 shows aspects of incident light 21 that is incident on the diffusion surface 8 at an incidence angle θ1 equal to or greater than the threshold value and diffused light 23 that is obtained in a case where the incident light 21 is diffused on the diffusion surface 8. FIG. 3 shows aspects of incident light 22 that is incident on the diffusion surface 8 at an incidence angle θ2 less than the threshold value and diffused light 24 that is obtained in a case where the incident light 22 is diffused on the diffusion surface 8. That is, in a case where the threshold value is denoted by θh, “θ1≥θh” and “θ2<θh” are satisfied. The spread angle of the diffused light 23 shown in FIG. 2 is smaller than the spread angle of the diffused light 24 shown in FIG. 3. Since the diffusion surface 8 is formed as described above, it is easy to achieve both a wide light distribution and a reduction in size and it is easy to increase the thickness of the diffuser 4.

The diffusion surface 8 may be formed using, for example, a holographic diffuser. A publicly known forming method in the related art can be used as a method of forming the holographic diffuser. For example, the holographic diffuser can be formed using a sol-gel method. Specifically, a solution (sol) containing SiO₂ serving as a material of the holographic diffuser is prepared, is applied onto a substrate and then gelates, and a coating is heated to be cured in a state where a master (mold) capable of transferring a surface uneven structure designed by a computer-generated hologram is in pressure contact with the coating having gelated. As a result, a holographic diffuser can be formed.

Alternatively, the diffusion surface 8 may be formed on one surface of the substrate 6. The diffusion surface 8 may consist of a film-like hologram element. A publicly known forming method in the related art can be used as a method of forming the film-like hologram element. For example, a diffuser is recorded on a photosensitive member using an exposure optical system, so that the film-like hologram element can be formed.

For example, glass can be used as the substrate 6. In a case where strength is desired to be further increased, the substrate 6 may be made of sapphire glass.

For example, FIG. 4 shows a light diffusion angle distribution of the diffused light on the diffusion surface 8 shown in FIG. 1. The light diffusion angle distribution can be represented while a diffusion angle φ is represented on a horizontal axis and the amount of light is represented on a vertical axis as shown in FIG. 4. FIG. 4 shows an example in which the threshold value is, for example, 12 degrees. In FIG. 4, a light diffusion angle distribution in a case where the incidence angle is equal to or greater than the threshold value is shown by a broken line, and a light diffusion angle distribution in a case where the incidence angle is less than the threshold value is shown by a solid line.

For example, angles φa, φb, φaq, and φbq defined as follows are also shown in FIG. 4. φa is a half width at half maximum of the light diffusion angle distribution in a case where the incidence angle is equal to or greater than the threshold value. φb is a half width at half maximum of the light diffusion angle distribution in a case where the incidence angle is less than the threshold value. φaq is a half width at a value of ¼ of the maximum amount of light in the light diffusion angle distribution in a case where the incidence angle is equal to or greater than the threshold value. φbq is a half width at a value of ¼ of the maximum amount of light in the light diffusion angle distribution in a case where the incidence angle is less than the threshold value.

The illumination optical system 10 according to the present embodiment is configured to satisfy Conditional Expression (1) with respect to φa and φb. In a case where a corresponding value of Conditional Expression (1) is set to be larger than a lower limit thereof, there is an advantage in ensuring a wide light distribution. In a case where the corresponding value of Conditional Expression (1) is set to be smaller than an upper limit thereof, there is an advantage in maintaining good transmission efficiency. This is based on the following circumstances. An outer peripheral surface of the diffuser 4 is often configured to be coated with an adhesive or the like in order to prevent components from falling off. In this configuration, light incident on the outer peripheral surface is absorbed by the adhesive or the like, and light transmission efficiency (the amount of emitted light/the amount of incident light) is lowered as much as that. In a case where the corresponding value of Conditional Expression (1) is set to be smaller than the upper limit thereof, the absorption of light on the outer peripheral surface can be reduced. Therefore, there is an advantage in maintaining good transmission efficiency.

$$0 \text{.1} < φ a / φ b < 0.7 \qquad ( 1 )$$

In order to obtain better characteristics, the lower limit of Conditional Expression (1) is more preferably 0.2, still more preferably 0.25, and even more preferably 0.3. In order to obtain better characteristics, the upper limit of Conditional Expression (1) is more preferably 0.65, still more preferably 0.6, and even more preferably 0.55. For example, the illumination optical system 10 preferably satisfies Conditional Expression (1-1), more preferably satisfies Conditional Expression (1-2), and still more preferably satisfies Conditional Expression (1-3).

$$0.2 < φ a / φ b < 0. 65 \qquad ( 1 - 1 )$$

$$0.25 < φ a / φ b < 0. 6 \qquad ( 1 - 2 )$$

$$0.3 < φ a / φ b < 0.55 \qquad ( 1 - 3 )$$

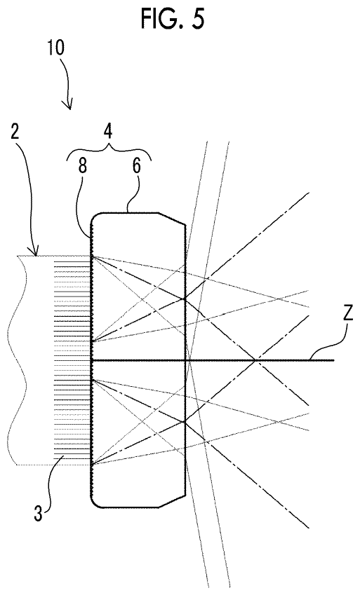

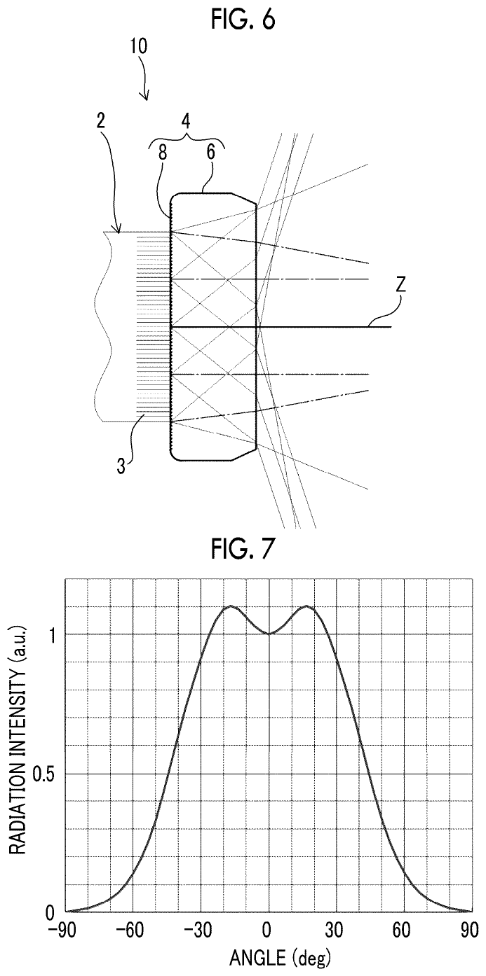

A configuration and optical paths of the diffuser 4 that satisfies Conditional Expression (1) and has the light diffusion angle distribution shown in FIG. 4 are shown in FIGS. 5 and 6. The optical paths in a case where the incidence angle is equal to or greater than the threshold value θh are shown in FIG. 5 by a solid line and a one-dot chain line. The optical paths in a case where the incidence angle is less than the threshold value θh are shown in FIG. 6 by a solid line and a one-dot chain line.

According to the present embodiment, it is possible to realize a wide light distribution as shown in FIGS. 5 and 6. Further, since the diffuser is likely to be broken as the thickness of the diffuser is reduced, there is a concern about the durability of the diffuser. However, in a case where the diffuser is configured as in the present embodiment, there is an advantage in achieving both high light transmission efficiency and a reduction in size while increasing the thickness of the diffuser. This point will be described below with reference to a technique disclosed in JP7141540B.

JP7141540B proposes the illumination optical system that includes the diffuser provided on the end surface of the light guide and can prevent a reduction in light utilization efficiency by satisfying “t/L≤1.6”. In JP7141540B, t is a thickness of the diffuser in a direction perpendicular to an emission surface of the diffuser, and L is a shortest distance between an end side of the emission surface of the diffuser and an end side of the end surface of the light guide in an in-plane direction of the emission surface. According to Expression of t/L≤1.6 in JP7141540B, in a case where L is reduced for a reduction in size, t must also be reduced. JP7141540B discloses an example in which t is set to 0.2 mm (millimeter), but there is a concern that the diffuser is likely to be broken in a case where 0.2 mm (millimeter) is set as the thickness of the diffuser disposed at an endoscope distal end. Further, the diffusion angle distribution of the diffuser disclosed in JP7141540B is independent of the incident angle and uniform. In contrast, since the light diffusion angle distribution on the diffusion surface 8 varies depending on the incidence angle in the illumination optical system 10 according to the present embodiment, it is possible to maintain high light transmission efficiency while increasing the thickness of the diffuser 4 and to realize a reduction in size and a wide light distribution.

It is preferable that the illumination optical system 10 according to the present embodiment further satisfies Conditional Expression (6) with respect to φa and φaq. In a case where a corresponding value of Conditional Expression (6) is set to be larger than a lower limit thereof, the absorption of light on the outer peripheral surface caused by the above-described adhesive or the like can be reduced. Therefore, there is an advantage in maintaining good transmission efficiency. In a case where the corresponding value of Conditional Expression (6) is set to be smaller than an upper limit thereof, there is an advantage in ensuring a wide light distribution.

$$0.5 < φ a / φ aq < 0.95 \qquad ( 6 )$$

In order to obtain better characteristics, the lower limit of Conditional Expression (6) is more preferably 0.6, still more preferably 0.7, and even more preferably 0.8. In order to obtain better characteristics, the upper limit of Conditional Expression (6) is more preferably 0.94, still more preferably 0.93, and even more preferably 0.92. For example, the illumination optical system 10 preferably satisfies Conditional Expression (6-1), more preferably satisfies Conditional Expression (6-2), and still more preferably satisfies Conditional Expression (6-3).

$$0.6 < φ a / φ aq < 0.94 \qquad ( 6 - 1 )$$

$$0.7 < φ a / φ aq < 0.93 \qquad ( 6 - 2 )$$

$$0.8 < φ a / φ aq < 0.92 \qquad ( 6 - 3 )$$

It is preferable that the illumination optical system 10 according to the present embodiment further satisfies Conditional Expression (7) with respect to φb and φbq. In a case where a corresponding value of Conditional Expression (7) is set to be larger than a lower limit thereof, the absorption of light on the outer peripheral surface caused by the above-described adhesive or the like can be reduced. Therefore, there is an advantage in maintaining good transmission efficiency. In a case where the corresponding value of Conditional Expression (7) is set to be smaller than an upper limit thereof, there is an advantage in ensuring a wide light distribution.

$$0.5 < φ b / φ bq < 0.95 \qquad ( 7 )$$

In order to obtain better characteristics, the lower limit of Conditional Expression (7) is more preferably 0.6, still more preferably 0.7, and even more preferably 0.8. In order to obtain better characteristics, the upper limit of Conditional Expression (7) is more preferably 0.94, still more preferably 0.93, and even more preferably 0.92. For example, the illumination optical system 10 preferably satisfies Conditional Expression (7-1), more preferably satisfies Conditional Expression (7-2), and still more preferably satisfies Conditional Expression (7-3).

$$0.6 < φ b / φ bq < 0.94 \qquad ( 7 - 1 )$$

$$0.7 < φ b / φ bq < 0.93 \qquad ( 7 - 2 )$$

$$0.8 < φ b / φ bq < 0.92 \qquad ( 7 - 3 )$$

Other preferable conditional expressions in the illumination optical system 10 according to the present embodiment will be described below. In the following description, in order to avoid lengthy description, the same symbols are used for factors having the same definition and repeated description of the symbols will be omitted. In the following conditional expressions, all units of angles are degrees.

It is preferable that the illumination optical system 10 satisfies Conditional Expression (2). Here, the thickness of the diffuser 4 is denoted by t. The radius of an outermost portion of the diffuser 4 is denoted by H. A radius of the light guide 2 is denoted by G. The threshold value is denoted by θh. A unit of θh is degrees. A refractive index of the substrate 6 with respect to a d line is denoted by N. Since the thickness of the diffusion surface 8 is configured to be extremely small in the diffuser 4 of the example shown in FIG. 1, the thickness of the substrate 6 can be approximated as the thickness of the diffuser 4. For example, FIG. 1 shows t, H, and G. In a case where a corresponding value of Conditional Expression (2) is set to be larger than a lower limit thereof, there is an advantage in ensuring a wide light distribution or there is an advantage in improving durability since the thickness of the diffuser 4 can be increased. In a case where the corresponding value of Conditional Expression (2) is set to be smaller than an upper limit thereof, the absorption of light on the outer peripheral surface caused by the above-described adhesive or the like can be reduced. Therefore, there is an advantage in maintaining good transmission efficiency.

$$0.4 < ( t / ( H - G ) ) \times tan ( θ h / N + φ a ) < 2 \qquad ( 2 )$$

In order to obtain better characteristics, the lower limit of Conditional Expression (2) is more preferably 0.47, still more preferably 0.5, and even more preferably 0.58. In order to obtain better characteristics, the upper limit of Conditional Expression (2) is more preferably 1.7, still more preferably 1.5, and even more preferably 1.2. For example, the illumination optical system 10 preferably satisfies Conditional Expression (2-1), more preferably satisfies Conditional Expression (2-2), and still more preferably satisfies Conditional Expression (2-3).

$$0.47 < ( t / ( H - G ) ) \times tan ( θ h / N + φ a ) < 1.7 \qquad ( 2 - 1 )$$

$$0.5 < ( t / ( H - G ) ) \times tan ( θ h / N + φ a ) < 1.5 \qquad ( 2 - 2 )$$

$$0.58 < ( t / ( H - G ) ) \times tan ( θ h / N + φ a ) < 1.2 \qquad ( 2 - 3 )$$

It is preferable that the illumination optical system 10 satisfies Conditional Expression (3). In a case where a corresponding value of Conditional Expression (3) is set to be larger than a lower limit thereof, there is an advantage in ensuring a wide light distribution or there is an advantage in improving durability since the thickness of the diffuser 4 can be increased. In a case where the corresponding value of Conditional Expression (3) is set to be smaller than an upper limit thereof, the absorption of light on the outer peripheral surface caused by the above-described adhesive or the like can be reduced. Therefore, there is an advantage in maintaining good transmission efficiency.

$$0.1 < ( t / H ) \times tan ( θ h / N + φ b ) < 1 \qquad ( 3 )$$

In order to obtain better characteristics, the lower limit of Conditional Expression (3) is more preferably 0.15, still more preferably 0.25, and even more preferably 0.3. In order to obtain better characteristics, the upper limit of Conditional Expression (3) is more preferably 0.9, still more preferably 0.8, and even more preferably 0.7. For example, the illumination optical system 10 preferably satisfies Conditional Expression (3-1), more preferably satisfies Conditional Expression (3-2), and still more preferably satisfies Conditional Expression (3-3).

$$0.15 < ( t / H ) \times tan ( θ h / N + φ b ) < 0.9 \qquad ( 3 - 1 )$$

$$0.25 < ( t / H ) \times tan ( θ h / N + φ b ) < 0.8 \qquad ( 3 - 2 )$$

$$0.3 < ( t / H ) \times tan ( θ h / N + φ b ) < 0.7 \qquad ( 3 - 3 )$$

It is preferable that the illumination optical system 10 satisfies Conditional Expression (4). In a case where a corresponding value of Conditional Expression (4) is set to be larger than a lower limit thereof, there is an advantage in maintaining a wide light distribution since pa is not excessively reduced or there is an advantage in maintaining good transmission efficiency since φb is not excessively increased. In a case where the corresponding value of Conditional Expression (4) is set to be smaller than an upper limit thereof, an effect obtained from the incidence angle dependence of a light diffusion angle distribution on the diffusion surface 8 can be made effective. Therefore, there is an advantage in ensuring a wide light distribution.

$$0.3 < ( θ h / N + φ a ) / ( θ h / N + φ b ) < 1 \qquad ( 4 )$$

In order to obtain better characteristics, the lower limit of Conditional Expression (4) is more preferably 0.34, still more preferably 0.37, and even more preferably 0.4. In order to obtain better characteristics, the upper limit of Conditional Expression (4) is more preferably 0.9, still more preferably 0.8, and even more preferably 0.7. For example, the illumination optical system 10 preferably satisfies Conditional Expression (4-1), more preferably satisfies Conditional Expression (4-2), and still more preferably satisfies Conditional Expression (4-3).

$$0.34 < ( θ h / N + φ a ) / ( θ h / N + φ b ) < 0.9 \qquad ( 4 - 1 )$$

$$0.37 < ( θ h / N + φ a ) / ( θ h / N + φ b ) < 0.8 \qquad ( 4 - 2 )$$

$$0.4 < ( θ h / N + φ a ) / ( θ h / N + φ b ) < 0.7 \qquad ( 4 - 3 )$$

It is preferable that the illumination optical system 10 according to the present embodiment satisfies Conditional Expression (5). In a case where a corresponding value of Conditional Expression (5) is set to be larger than a lower limit thereof, it is possible to prevent a central portion of an observation visual field from be darkened since the intensity of light emitted from the diffuser 4 is excessively reduced near the optical axis. In a case where the corresponding value of Conditional Expression (5) is set to be smaller than an upper limit thereof, the absorption of light on the outer peripheral surface caused by the above-described adhesive or the like can be reduced. Therefore, there is an advantage in maintaining good transmission efficiency.

$$3 < φ a - θ h / N < 10 \qquad ( 5 )$$

In order to obtain better characteristics, the lower limit of Conditional Expression (5) is more preferably 4, still more preferably 5, and even preferably 6. In order to obtain better characteristics, the upper limit of Conditional Expression (5) is more preferably 9, still more preferably 8.5, and even more preferably 8. For example, the illumination optical system 10 preferably satisfies Conditional Expression (5-1), more preferably satisfies Conditional Expression (5-2), and still more preferably satisfies Conditional Expression (5-3).

$$4 < φ a - θ h / N < 9 \qquad ( 5 - 1 )$$

$$5 < φ a - θ h / N < 8.5 \qquad ( 5 - 2 )$$

$$6 < φ a - θ h / N < 8 \qquad ( 5 - 3 )$$

The prevention of a reduction in the intensity of the emitted light has been described in Conditional Expression (5). On the contrary, in a case where it is desired to suppress an excessive increase in the intensity of light emitted from the diffuser 4 near the optical axis, a light shielding member may be disposed on the central axis of the light guide 2. In general, the intensity of illumination light on the optical axis and near the optical axis is higher than that at a position away from the optical axis toward an outer peripheral side. In a procedure using an endoscope, blood or the like may adhere to an illumination window provided closer to an irradiation target than an illumination optical system. In a case where the intensity of light is too high, there is a concern that the blood adhering to the illumination window may coagulate due to illumination light. In a case where the light guide 2 is configured to include a light shielding member on the central axis thereof, the intensity of light on the optical axis and near the optical axis can be reduced. Therefore, it is easy to prevent blood, which adheres to the illumination window, from coagulating. The term “central” of “on the central axis” refers to not only exactly “central” but also substantially “central” that includes an error generally allowed in the technical field to which the technology of the present disclosure belongs.

Next, examples of the illumination optical system according to the embodiment of the present disclosure will be described with reference to the drawings. All of Examples 1 to 6 to be described below have a configuration that is rotationally symmetric with respect to the optical axis Z as a rotation axis. In the following description of Examples, components having the same configuration will be denoted by the same reference numeral and the repeated description thereof will be omitted.

### Example 1

Since a configuration of an illumination optical system 10 of Example 1 is shown in FIG. 1 and is as described above, a part of repeated description thereof will be omitted here. The illumination optical system 10 includes the light guide 2 and the diffuser 4. The diffuser 4 includes a substrate 6 and a diffusion surface 8 that is provided on a light guide-side surface of the substrate 6. A threshold value of an incidence angle of light on the diffusion surface 8 is 12 degrees. FIG. 4 shows a light diffusion angle distribution on the diffusion surface 8. FIG. 5 shows optical paths in a case where the incidence angle is equal to or greater than the threshold value, and FIG. 6 shows optical paths in a case where the incidence angle is less than the threshold value. Since the description regarding FIGS. 4, 5, and 6 has been given above, repeated description will be omitted here.

FIG. 7 shows a graph of light distribution characteristics of light emitted from the illumination optical system 10. In FIG. 7, an angle from the optical axis Z is represented on a horizontal axis and radiation intensity is represented on a vertical axis. A method of illustrating the graph of light distribution characteristics is the same in Examples to be described below. Various data of the illumination optical system 10 of Example 1 and a half width at half maximum of the graph of light distribution characteristics shown in FIG. 7 are collectively shown in Table 1 to be described below together with values of other examples.

### Example 2

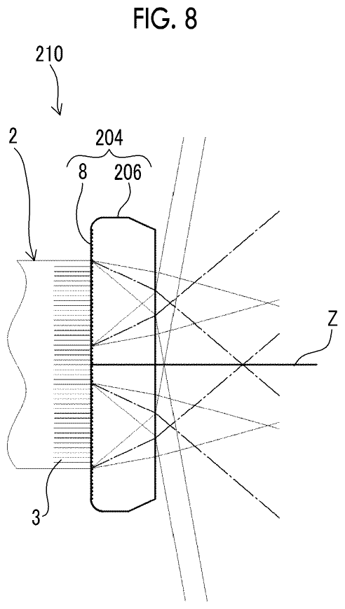

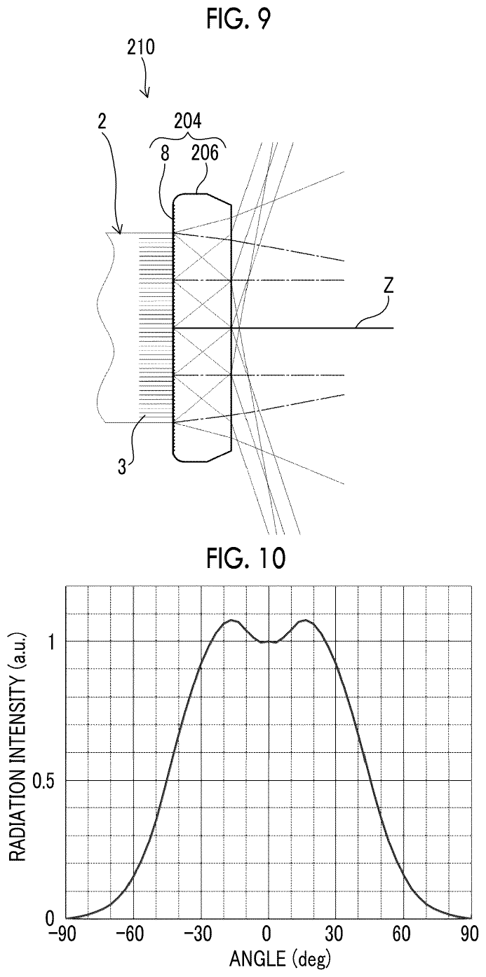

FIGS. 8 and 9 show a configuration and optical paths of an illumination optical system 210 of Example 2 in a cross section including an optical axis Z. FIG. 8 shows optical paths in a case where an incidence angle is equal to or greater than a threshold value, and FIG. 9 shows optical paths in a case where the incidence angle is less than the threshold value. The illumination optical system 210 includes the light guide 2 and a diffuser 204. The diffuser 204 includes a substrate 206 and a diffusion surface 8 that is provided on a light guide-side surface of the substrate 206. A threshold value of an incidence angle of light on the diffusion surface 8 is 12 degrees. A light diffusion angle distribution on the diffusion surface 8 is shown in FIG. 4. The thickness of the diffuser 204 of the illumination optical system 210 of Example 2 is smaller than the thickness of the diffuser 4 of the illumination optical system 10 of Example 1. FIG. 10 shows a graph of light distribution characteristics of light emitted from the illumination optical system 210.

### Example 3

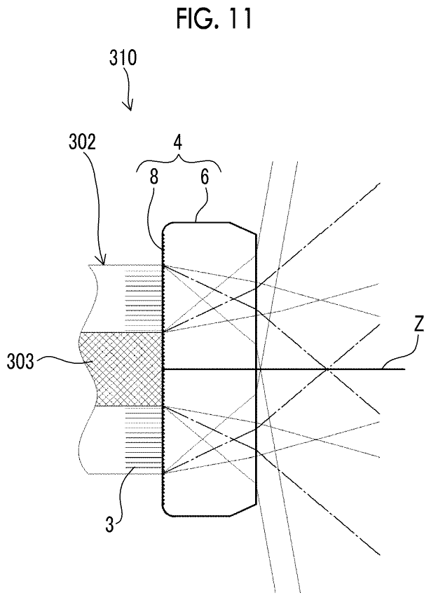

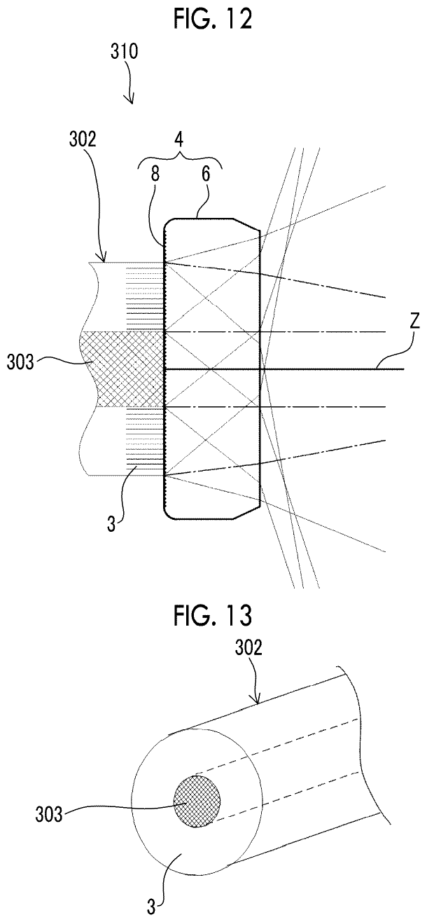

FIGS. 11 and 12 show a configuration and optical paths of an illumination optical system 310 of Example 3 in a cross section including an optical axis Z. FIG. 11 shows optical paths in a case where an incidence angle is equal to or greater than a threshold value, and FIG. 12 shows optical paths in a case where the incidence angle is less than the threshold value. The illumination optical system 310 includes a light guide 302 and the diffuser 4. The diffuser 4 of the illumination optical system 310 has the same configuration as the diffuser 4 of the illumination optical system 10.

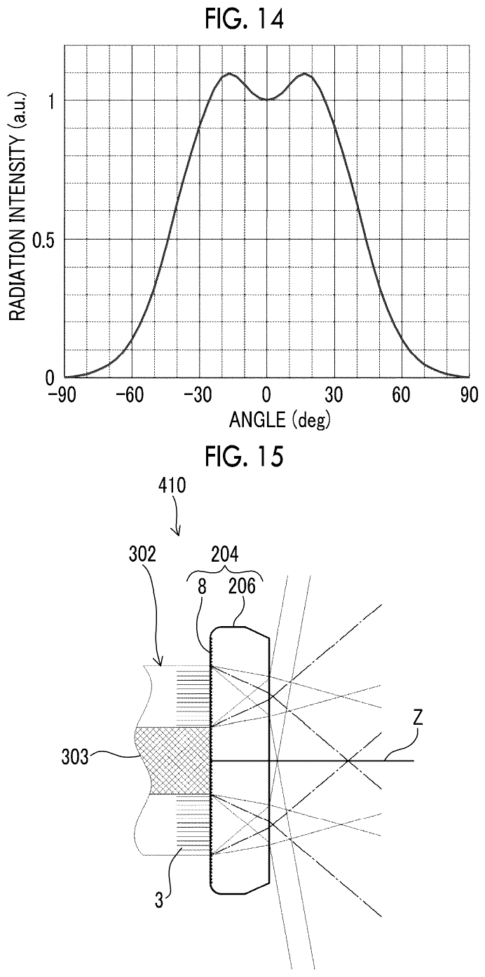

A wedge 303, which is a light shielding member, is disposed on a central axis of the light guide 302. FIG. 13 is a schematic perspective view of the light guide 302. The light guide 302 includes the wedge 303 that is disposed on the central axis and a number of optical fibers 3 that are arranged around the wedge 303. In FIG. 13, the individual optical fibers 3 arranged around the wedge 303 are not shown and only the reference numeral of the optical fibers 3 is shown. The wedge 303 consists of, for example, a wire made of metal. FIG. 14 shows a graph of light distribution characteristics of light emitted from the illumination optical system 310.

### Example 4

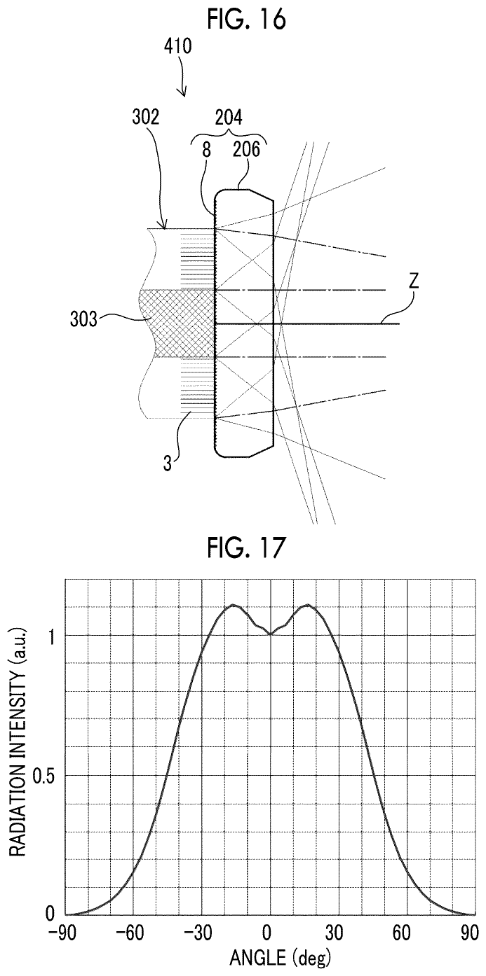

FIGS. 15 and 16 show a configuration and optical paths of an illumination optical system 410 of Example 4 in a cross section including an optical axis Z. FIG. 15 shows optical paths in a case where an incidence angle is equal to or greater than a threshold value, and FIG. 16 shows optical paths in a case where the incidence angle is less than the threshold value. The illumination optical system 410 includes the light guide 302 and the diffuser 204. The diffuser 204 includes a substrate 206 and a diffusion surface 8 that is provided on a light guide-side surface of the substrate 206. A threshold value of an incidence angle of light on the diffusion surface 8 is 12 degrees. A light diffusion angle distribution on the diffusion surface 8 is shown in FIG. 4. The thickness of the diffuser 204 of the illumination optical system 410 of Example 4 is smaller than the thickness of the diffuser 4 of the illumination optical system 310 of Example 3. FIG. 17 shows a graph of light distribution characteristics of light emitted from the illumination optical system 410.

### Example 5

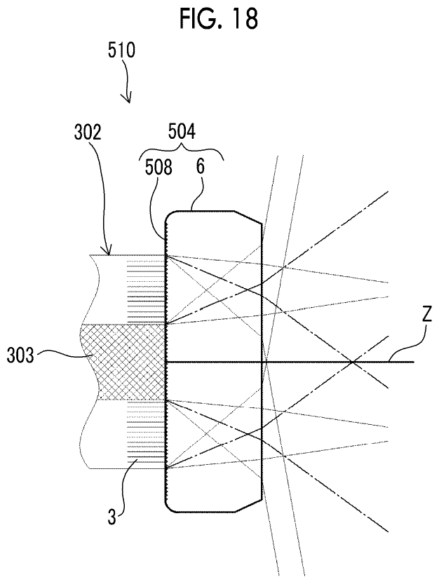

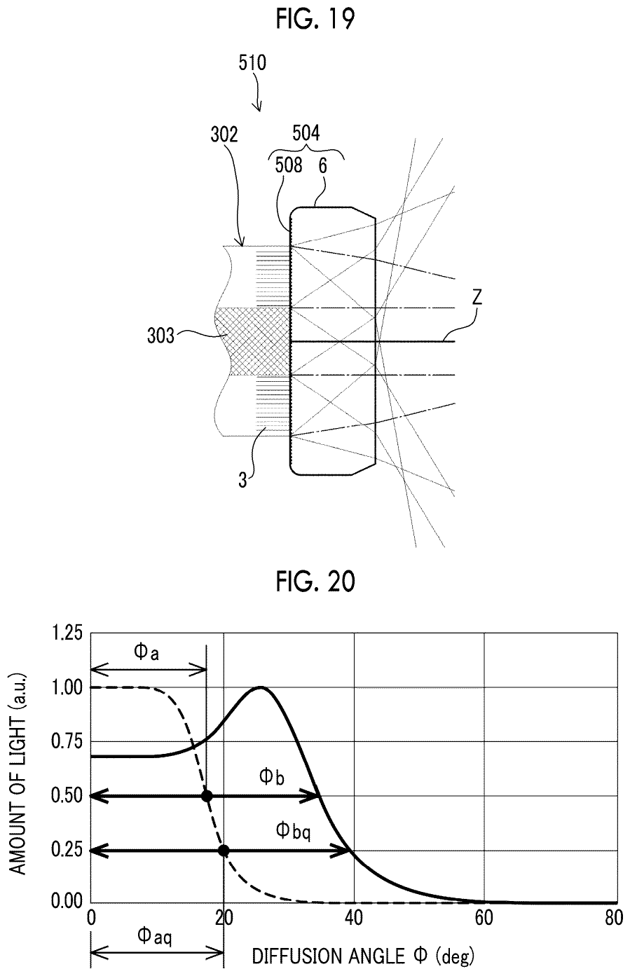

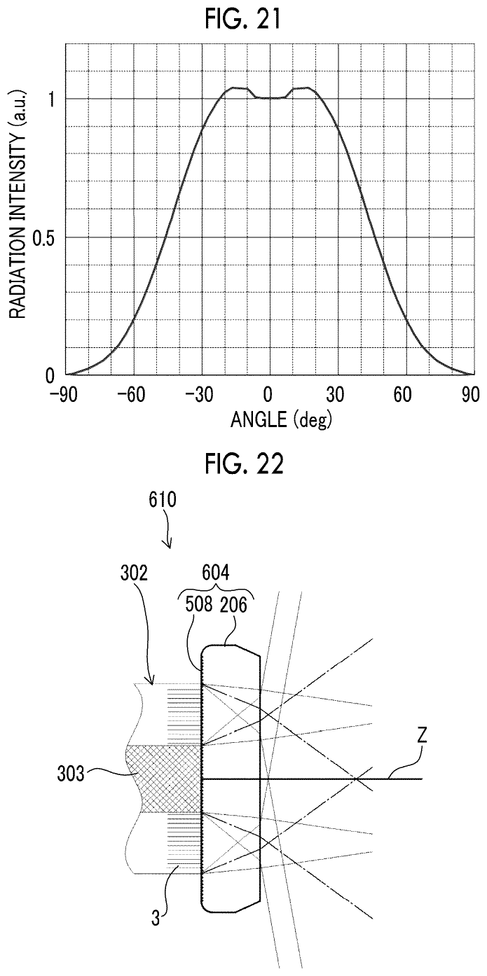

FIGS. 18 and 19 show a configuration and optical paths of an illumination optical system 510 of Example 5 in a cross section including an optical axis Z. FIG. 18 shows optical paths in a case where an incidence angle is equal to or greater than a threshold value, and FIG. 19 shows optical paths in a case where the incidence angle is less than the threshold value. The illumination optical system 510 includes the light guide 302 and a diffuser 504. The diffuser 504 includes a substrate 6 and a diffusion surface 508 that is provided on a light guide-side surface of the substrate 6. A threshold value θh of an incidence angle of light on the diffusion surface 508 is 15 degrees. FIG. 20 shows a light diffusion angle distribution of diffused light on the diffusion surface 508. FIG. 21 shows a graph of light distribution characteristics of light emitted from the illumination optical system 510.

### Example 6

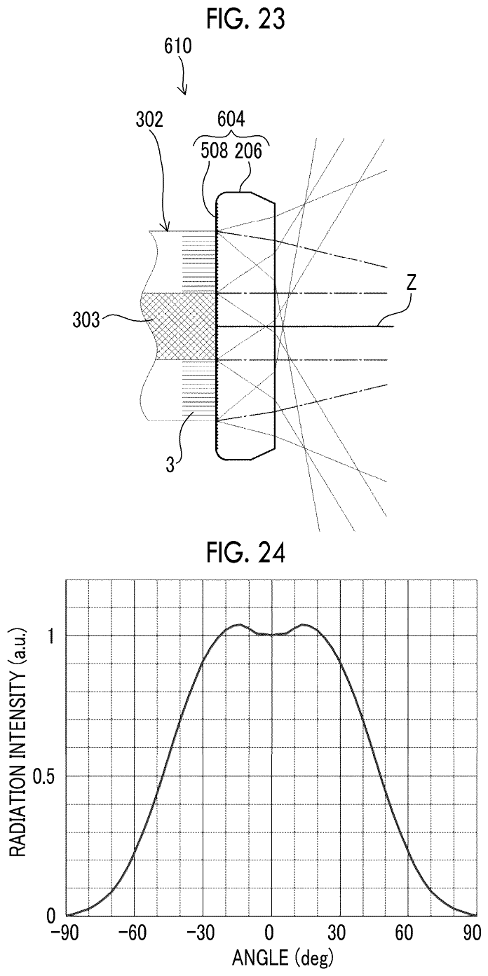

FIGS. 22 and 23 show a configuration and optical paths of an illumination optical system 610 of Example 6 in a cross section including an optical axis Z. FIG. 22 shows optical paths in a case where an incidence angle is equal to or greater than a threshold value, and FIG. 23 shows optical paths in a case where the incidence angle is less than the threshold value. The illumination optical system 610 includes the light guide 302 and a diffuser 604. The diffuser 604 includes the substrate 206 and the diffusion surface 508 that is provided on the light guide-side surface of the substrate 206. A threshold value θh of an incidence angle of light on the diffusion surface 508 is 15 degrees. A light diffusion angle distribution on the diffusion surface 508 is shown in FIG. 20. The thickness of the diffuser 604 of the illumination optical system 610 of Example 6 is smaller than the thickness of the diffuser 504 of the illumination optical system 510 of Example 5. FIG. 24 shows a graph of light distribution characteristics of light emitted from the illumination optical system 610.

Table 1 shows various data of each of the illumination optical systems of Examples 1 to 6. Table 1 shows not only the respective values used in the above-described conditional expressions but also values to be described below. The row of “v” shows the Abbe number of the substrate with respect to the d line. The row of “Width of light distribution” shows a half width at half maximum of a graph of light distribution characteristics of light emitted from each illumination optical system. The row of “Wedge diameter” shows the diameter of the wedge 303.

In the data shown in each table of the present specification, millimeters are used as a unit of length and degrees are used as a unit of angle. However, other appropriate units can also be used since the optical system can be used even in a case where the optical system is enlarged or reduced in proportion. Further, the values shown in the data of each table are values rounded to predetermined digits.

TABLE 1

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| t | 0.38 | 0.26 | 0.38 | 0.26 | 0.38 | 0.26 |
| G | 0.425 | 0.425 | 0.425 | 0.425 | 0.425 | 0.425 |
| H | 0.60 | 0.60 | 0.60 | 0.60 | 0.60 | 0.60 |
| θh | 12 | 12 | 12 | 12 | 15 | 15 |
| N | 1.516 | 1.516 | 1.516 | 1.516 | 1.516 | 1.516 |
| φa | 15.1 | 15.1 | 15.1 | 15.1 | 17.5 | 17.5 |
| φb | 38.8 | 38.8 | 38.8 | 38.8 | 34.4 | 34.4 |
| φaq | 16.9 | 16.9 | 16.9 | 16.9 | 20.2 | 20.2 |
| φbq | 43.1 | 43.1 | 43.1 | 43.1 | 39.0 | 39.0 |
| ν | 64.06 | 64.06 | 64.06 | 64.06 | 64.06 | 64.06 |
| Width of | 44.2° | 45.1° | 43.8° | 45.4° | 43.8° | 47.8° |
| light | | | | | | |
| distribution | | | | | | |
| Wedge | | | 0.30 | 0.30 | 0.30 | 0.30 |
| diameter | | | | | | |

Table 2 shows the corresponding values of Conditional Expressions (1) to (7) of each of the illumination optical systems of Examples 1 to 6. Preferred ranges of the conditional expressions may be set using the values shown in Table 2 as the upper limits or the lower limits of the conditional expressions.

TABLE 2

| Expression | | | | | | | |
|---|---|---|---|---|---|---|---|
| No. | | Example 1 | Example 2 | Example 3 | Example 4 | Example 5 | Example 6 |
| (1) | φa/φb | 0.39 | 0.39 | 0.39 | 0.39 | 0.51 | 0.51 |
| (2) | (t/(H-G)) × | 0.92 | 0.63 | 0.92 | 0.63 | 1.13 | 0.77 |
| | tan(θh/N + | | | | | | |
| | φa) | | | | | | |
| (3) | (t/H) × | 0.67 | 0.46 | 0.67 | 0.46 | 0.62 | 0.42 |
| | tan(θh/N + | | | | | | |
| | φb) | | | | | | |
| (4) | (θh/N + | 0.49 | 0.49 | 0.49 | 0.49 | 0.62 | 0.62 |
| | φa)/(θh/ | | | | | | |
| | N + φb) | | | | | | |
| (5) | φa-θh/N | 7.18 | 7.18 | 7.18 | 7.18 | 7.61 | 7.61 |
| (6) | φa/φaq | 0.89 | 0.89 | 0.89 | 0.89 | 0.87 | 0.87 |
| (7) | φb/φbq | 0.90 | 0.90 | 0.90 | 0.90 | 0.88 | 0.88 |

As described above, all of the respective illumination optical systems of Examples 1 to 6 are configured to be small but have a wide light distribution angle.

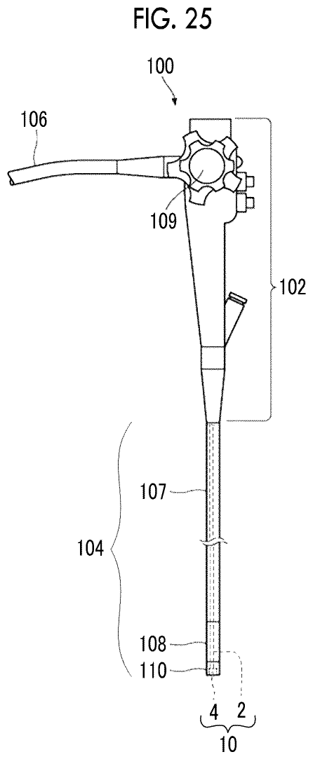

Next, an endoscope according to an embodiment of the present disclosure will be described. FIG. 25 shows a diagram showing a schematic configuration of the entire endoscope according to the embodiment of the present disclosure. The endoscope 100 shown in FIG. 25 mainly comprises an operation unit 102, an insertion unit 104, and a universal cord 106 that is to be connected to a connector part (not shown). A large portion of the insertion unit 104 is a soft part 107 that is bendable in any direction along an insertion path, a bendable part 108 is connected to a distal end of the soft part 107, and a distal end part 110 is connected to a distal end of the bendable part 108. The bendable part 108 is provided to allow the distal end part 110 to face in a desired direction, and can be operated to be bent by the rotational movement of bending operation knobs 109 provided on the operation unit 102.

The diffuser 4 of the embodiment of the present disclosure is disposed at an inner distal end of the distal end part 110. Further, the light guide 2 is disposed in the endoscope such that the distal end of the light guide 2 faces the diffuser 4. The illumination optical system 10 according to the embodiment of the present disclosure is configured to include the light guide 2 and the diffuser 4. The light guide 2 is partially omitted in FIG. 25.

A technique of the present disclosure has been described above using the embodiments and the examples, but the technique of the present disclosure may have various modifications without being limited to the embodiments and the examples. For example, the dimensions of each portion, the threshold value of the incidence angle, the refractive index of the substrate, the Abbe number, and the like are not limited to the values shown in the above-described examples, and other values may be adopted.

With regard to the embodiments and Examples described above, the following supplementary notes will be further disclosed.

### Supplementary Note 1

An illumination optical system comprising:
a light guide of an endoscope; and
a diffuser that is disposed on an emission side of the light guide and diffuses light emitted from the light guide,
in which the diffuser includes a substrate and a diffusion surface that is provided on a light guide-side surface of the substrate,
a light diffusion angle distribution on the diffusion surface varies depending on an incidence angle of light incident on the diffusion surface, and
in a case where a half width at half maximum of the light diffusion angle distribution in a case where the incidence angle is equal to or greater than a predetermined threshold value is denoted by φa, a half width at half maximum of the light diffusion angle distribution in a case where the incidence angle is less than the threshold value is denoted by φb, and units of pa and φb are degrees, Conditional Expression (1), which is represented by 0.1<φa/φb<0.7 (1), is satisfied.

### Supplementary Note 2

The illumination optical system according to supplementary note 1,
in which, in a case where a thickness of the diffuser is denoted by t, a radius of an outermost portion of the diffuser is denoted by H, a radius of the light guide is denoted by G, the threshold value is denoted by θh, a unit of θh is degrees, and a refractive index of the substrate with respect to a d line is denoted by N, Conditional Expression (2), which is represented by 0.4<(t/(H−G))×tan (θh/N+φa)<2 (2), is satisfied.

### Supplementary Note 3

The illumination optical system according to supplementary note 1 or 2, in which, in a case where a thickness of the diffuser is denoted by t, a radius of an
outermost portion of the diffuser is denoted by H, the threshold value is denoted by θh, a unit of θh is degrees, and a refractive index of the substrate with respect to a d line is denoted by N, Conditional Expression (3), which is represented by 0.1<(t/H)×tan (θh/N+φb)<1 (3), is satisfied.

### Supplementary Note 4

The illumination optical system according to any one of supplementary notes 1 to 3,
in which, in a case where the threshold value is denoted by θh, a unit of θh is degrees, and a refractive index of the substrate with respect to a d line is denoted by N, Conditional Expression (4), which is represented by 0.3<(θh/N+pa)/(θh/N+φb)<1 (4), is satisfied.

### Supplementary Note 5

The illumination optical system according to any one of supplementary notes 1 to 4, in which, in a case where the threshold value is denoted by θh, a unit of θh is degrees, and a refractive index of the substrate with respect to a d line is denoted by N, Conditional Expression (5), which is represented by 3<φa−θh/N<10 (5), is satisfied.

### Supplementary Note 6

The illumination optical system according to any one of supplementary notes 1 to 5,
in which, in a case where a half width at a value of ¼ of a maximum amount of light in the light diffusion angle distribution in a case where the incidence angle is equal to or greater than the threshold value is denoted by φaq, Conditional Expression (6), which is represented by 0.5<φa/φaq<0.95 (6), is satisfied.

### Supplementary Note 7

The illumination optical system according to any one of supplementary notes 1 to 6,
in which, in a case where a half width at a value of ¼ of a maximum amount of light in the light diffusion angle distribution in a case where the incidence angle is less than the threshold value is denoted by φbq, Conditional Expression (7), which is represented by 0.5<φb/φbq<0.95 (7), is satisfied.

### Supplementary Note 8

The illumination optical system according to any one of supplementary notes 1 to 7,
in which the light guide includes a light shielding member on a central axis thereof.

### Supplementary Note 9

An endoscope comprising:
the illumination optical system according to any one of supplementary notes 1 to 8.

What is claimed is:

1. An illumination optical system comprising:
a light guide of an endoscope; and
a diffuser that is disposed on an emission side of the light guide and diffuses light emitted from the light guide,
wherein the diffuser includes a substrate and a diffusion surface that is provided on a light guide-side surface of the substrate,
a light diffusion angle distribution on the diffusion surface varies depending on an incidence angle of light incident on the diffusion surface, and
in a case where a half width at half maximum of the light diffusion angle distribution in a case where the incidence angle is equal to or greater than a predetermined threshold value is denoted by φa, a half width at half maximum of the light diffusion angle distribution in a case where the incidence angle is less than the threshold value is denoted by φb, and units of φa and φb are degrees, Conditional Expression (1), which is represented by 0.1<φa/φb<0.7 (1), is satisfied.

2. The illumination optical system according to claim 1,
wherein, in a case where a thickness of the diffuser is denoted by t, a radius of an outermost portion of the diffuser is denoted by H, a radius of the light guide is denoted by G, the threshold value is denoted by θh, a unit of θh is degrees, and a refractive index of the substrate with respect to a d line is denoted by N, Conditional Expression (2), which is represented by 0.4<(t/(H−G))×tan (θh/Nφa)<2 (2), is satisfied.

3. The illumination optical system according to claim 1,
wherein, in a case where a thickness of the diffuser is denoted by t, a radius of an outermost portion of the diffuser is denoted by H, the threshold value is denoted by θh, a unit of θh is degrees, and a refractive index of the substrate with respect to a d line is denoted by N, Conditional Expression (3), which is represented by 0.1<(t/H)×tan (θh/N+φb)<1 (3), is satisfied.

4. The illumination optical system according to claim 1,
wherein, in a case where the threshold value is denoted by θh, a unit of θh is degrees, and a refractive index of the substrate with respect to a d line is denoted by N, Conditional Expression (4), which is represented by 0.3<(θh/N+φa)/(θh/N+φb)<1 (4), is satisfied.

5. The illumination optical system according to claim 1,
wherein, in a case where the threshold value is denoted by θh, a unit of θh is degrees, and a refractive index of the substrate with respect to a d line is denoted by N, Conditional Expression (5), which is represented by 3φa−θh/N<10 (5), is satisfied.

6. The illumination optical system according to claim 1,
wherein, in a case where a half width at a value of ¼ of a maximum amount of light in the light diffusion angle distribution in a case where the incidence angle is equal to or greater than the threshold value is denoted by φaq, Conditional Expression (6), which is represented by 0.5<φa/φaq<0.95 (6), is satisfied.

7. The illumination optical system according to claim 1,
wherein, in a case where a half width at a value of ¼ of a maximum amount of light in the light diffusion angle distribution in a case where the incidence angle is less than the threshold value is denoted by φbq, Conditional Expression (7), which is represented by 0.5<φb/φbq<0.95 (7), is satisfied.

8. The illumination optical system according to claim 1,
wherein the light guide includes a light shielding member on a central axis thereof.

9. An endoscope comprising:
the illumination optical system according to claim 1.
